(19) United States
(12) Patent Application Publication
(10) Pub. No.: US 2015/0003790 A1
(43) Pub. Date: Jan. 1, 2015

(54) FIELD MOUNTABLE DUPLEX OPTICAL FIBER CONNECTOR WITH MECHANICAL SPLICE ELEMENTS

(71) Applicant: 3M INNOVATIVE PROPERTIES COMPANY, ST. PAUL, MN (US)

(72) Inventors: Canhui Wu, Zhongshan City (CN); Xiaoxian Li, Zhongshan City (CN); Jiang Guan, Guangzhou City (CN)

(21) Appl. No.: 14/367,421

(22) PCT Filed: Jan. 12, 2012
(86) PCT No.: PCT/CN2012/070270

§ 371 Date: Jun. 20, 2014

(51) Int. Cl. G02B 6/38

(52) U.S. Cl. CPC G02B 6/3887
USPC 385/81

(57) ABSTRACT

A field mountable fiber optic connector for terminating a dual optical fiber cable is provided. The fiber optic connector includes a bifurcated housing having first and second spaced apart, parallel backbone portions extending from a cable furcation unit, first and second collar bodies respectively disposed in the first and second backbone portions, and first and second outer housings respectively disposed over the first and second backbone portions and wherein the first and second outer housings are configured to be mateable with two adjacent receptacles. The cable furcation unit comprises a threaded receiving portion and a fiber jacket clamping portion to clamp a cable jacket of the dual optical fiber cable. The fiber optic connector further includes a boot attachable to the threaded receiving portion of the cable furcation unit, wherein the boot actuates the fiber jacket clamping portion of the cable furcation unit upon attachment to the threaded receiving portion.

### BACKGROUND

1. Field of the Invention

The present invention is directed to a duplex fiber optic connector. In particular, the duplex fiber optic connector is mountable on an optical fiber cable having two optical fibers disposed therein.

2. Related Art

Mechanical fiber optic connectors for optical fiber cables containing a single optical fiber for use in the telecommunications industry are known. For example, LC, ST, FC, and SC fiber optic connectors are widely used.

Hybrid mechanical optical fiber splice connectors are known, as described in JP Patent No. 3445479, PCT Publication No. WO 2006/019516 and PCT Publication No. WO 2006/019515. However, these hybrid splice connectors are not compatible with standard connector formats and require significant piecewise assembly of the connector in the field. The handling and orientation of multiple small pieces of the connector can result in incorrect connector assembly that may either result in decreased performance or increase the chance of damaging the fiber.

More recently, U.S. Pat. No. 7,369,738 describes a fiber optic connector that includes a pre-polished fiber stub disposed in ferrule that is spliced to a field fiber with a mechanical splice. Such a connector, called an NPC, is now commercially available through 3M Company (St. Paul, Minn.).

In addition duplex LC connectors are known. These duplex LC connectors comprise two separate LC connectors that are connected together by a separate clip or other mechanical connection means. Each of these LC connectors is designed to be attached to optical fiber cable having a single fiber or a multi-fiber cable when only a single fiber is being terminated.

Finally, factory prepared patch cords having duplex LC connectors are beginning to emerge. However, these factory mounted duplex connectors are adhesively mounted onto the ends of the patch cord which cannot be conveniently achieved in the field. Therefore, a field mountable fiber optic connector is needed for terminating dual fiber optical fiber cables.

### SUMMARY

According to a first aspect of the present invention, a field mountable fiber optic connector for terminating a dual optical fiber cable is provided. The fiber optic connector includes a bifurcated housing having first and second spaced apart, parallel backbone portions extending from a cable furcation unit, first and second collar bodies respectively disposed in the first and second backbone portions, and first and second outer housings respectively disposed over the first and second backbone portions and wherein the first and second outer housings are configured to be mateable with two adjacent receptacles. The cable furcation unit comprises a threaded receiving portion and a fiber jacket clamping portion to clamp a cable jacket of the dual optical fiber cable. The fiber optic connector further includes a boot attachable to the threaded receiving portion of the cable furcation unit, wherein the boot actuates the fiber jacket clamping portion of the cable furcation unit upon attachment to the threaded receiving portion.

In an exemplary aspect, each collar body includes a fiber stub disposed in a first end of the collar body, the fiber stub including a stub fiber mounted in a ferrule and having a first end proximate to an end face of the ferrule and a second end, wherein each collar body further includes a mechanical splice device disposed within the collar body. The mechanical splice device is configured to splice the second end of the stub fiber to an optical fiber from the dual optical fiber cable.

In a second exemplary embodiment, the fiber optic connector includes a cable furcation unit having a first end and a second end, first and second outer housings attached to the first end of the a cable furcation unit, wherein the first and second outer housings are configured to be mateable with two adjacent receptacles, and first and second collar bodies respectively disposed in the first and second outer housing units. The cable furcation unit comprises a threaded receiving portion and a fiber jacket clamping portion to clamp a cable jacket of the dual optical fiber cable. The fiber optic connector further includes a boot attachable to the threaded receiving portion of the cable furcation unit, wherein the boot actuates the fiber jacket clamping portion of the cable furcation unit upon attachment to the threaded receiving portion.

In an exemplary aspect, each collar body includes a fiber stub disposed in a first end of the collar body, the fiber stub including a stub fiber mounted in a ferrule and having a first end proximate to an end face of the ferrule and a second end, wherein each collar body further includes a mechanical splice device disposed within the collar body. The mechanical splice device is configured to splice the second end of the stub fiber to an optical fiber from the dual optical fiber cable.

The above summary of the present invention is not intended to describe each illustrated embodiment or every implementation of the present invention. The figures and the detailed description that follows more particularly exemplify these embodiments.

### DETAILED DESCRIPTION OF THE DRAWINGS

The present invention will be further described with reference to the accompanying drawings, wherein:

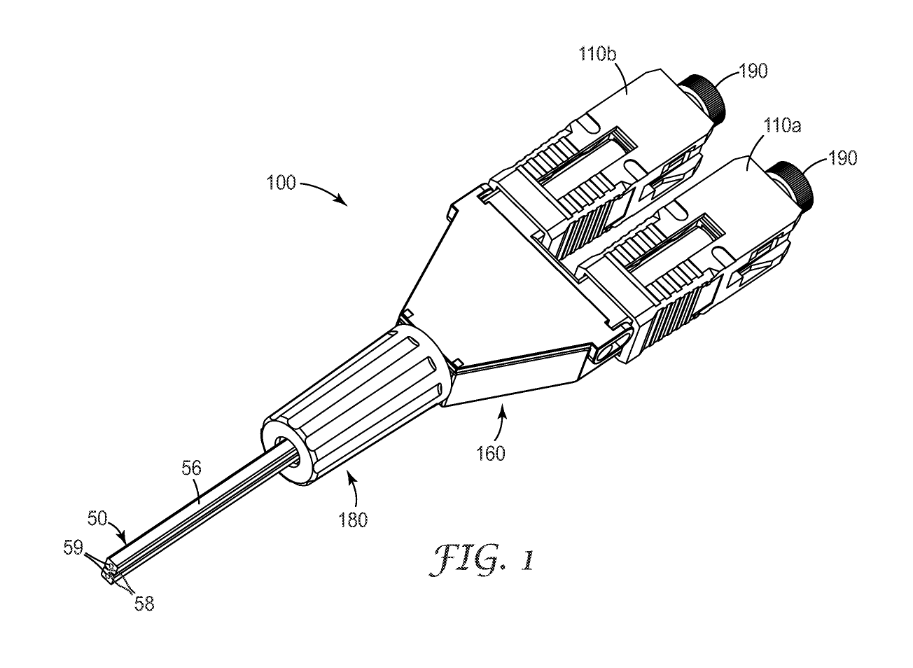

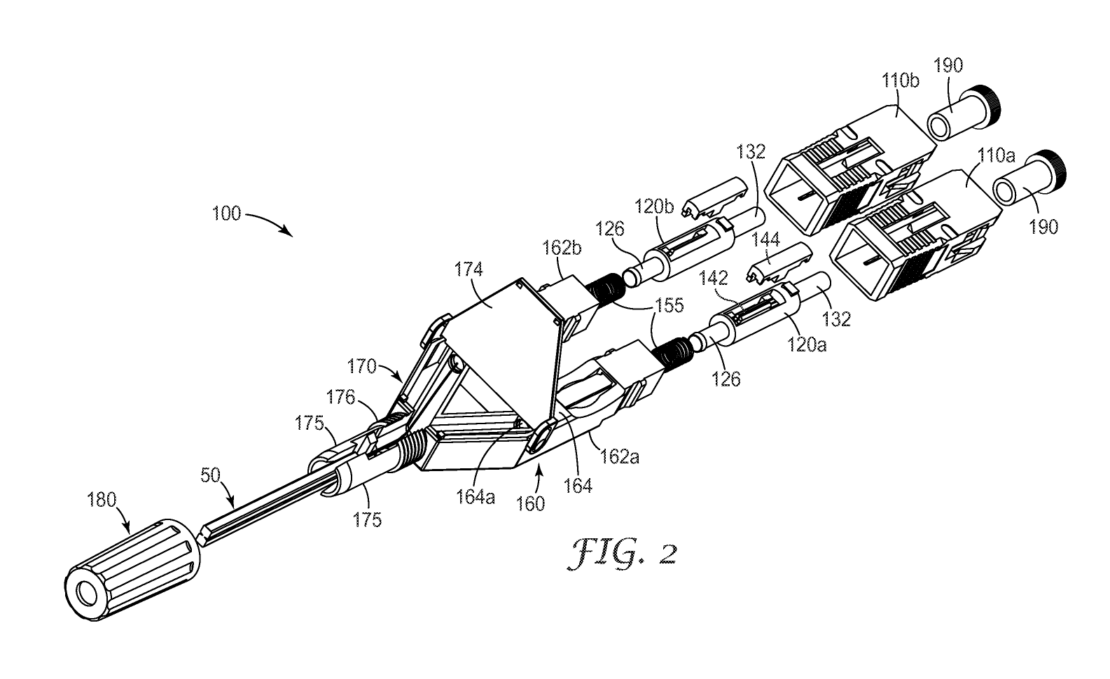

FIG. 1 is an isometric view of a fiber optic connector according to an embodiment of the present invention.

FIG. 2 is an exploded view of a fiber optic connector according to an embodiment of the present invention.

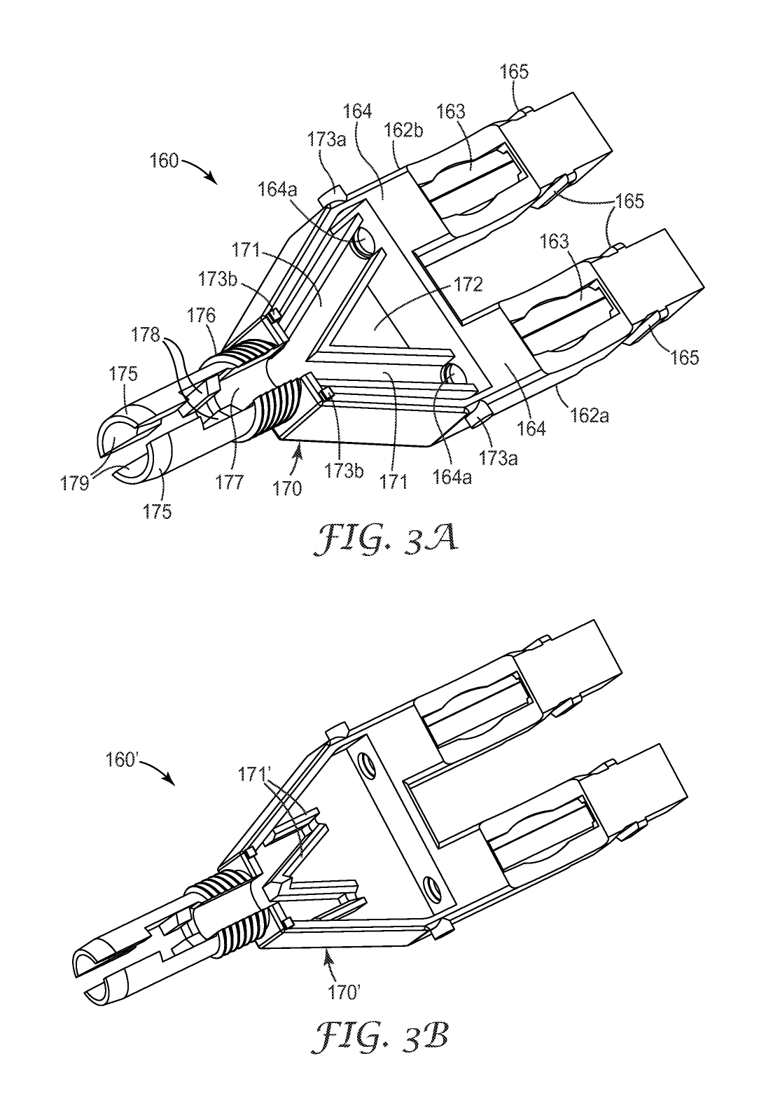

FIGS. 3A and 3B are isometric views of two alternative exemplary bifurcated housings of a fiber optic connector according to an embodiment of the present invention.

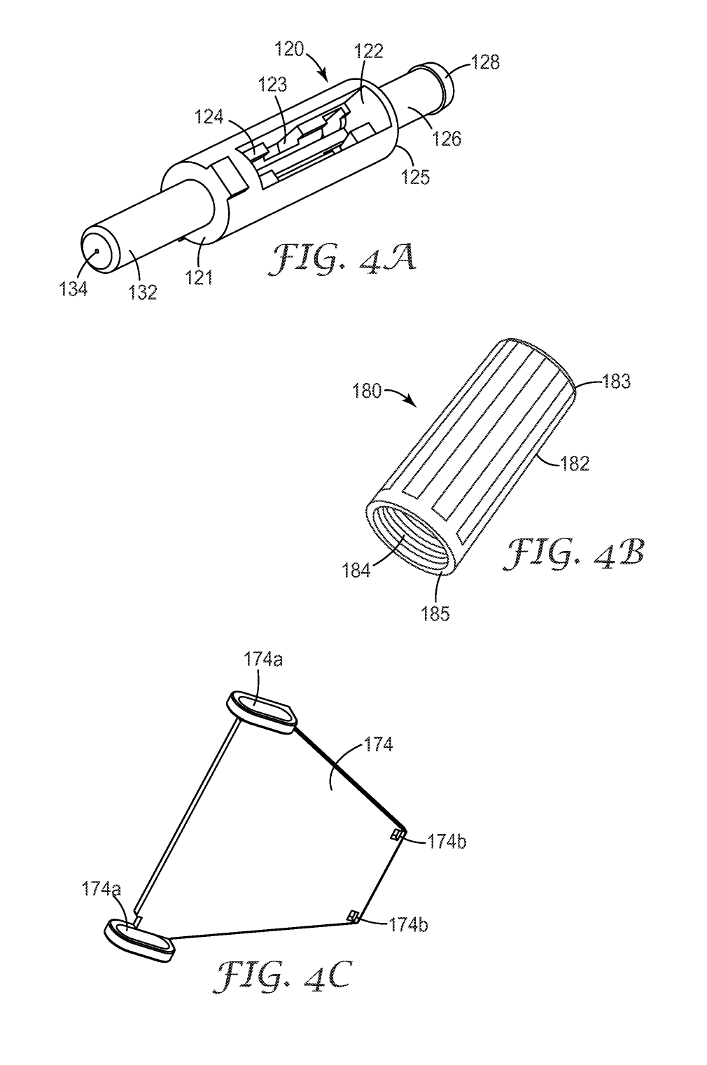

FIG. 4A is an isometric view of an exemplary collar body of a fiber optic connector according to an embodiment of the present invention.

FIG. 4B is a side view of an exemplary boot of a fiber optic connector according to an embodiment of the present invention.

FIG. 4C is an isometric view of an exemplary furcation cover of a fiber optic connector according to an embodiment of the present invention.

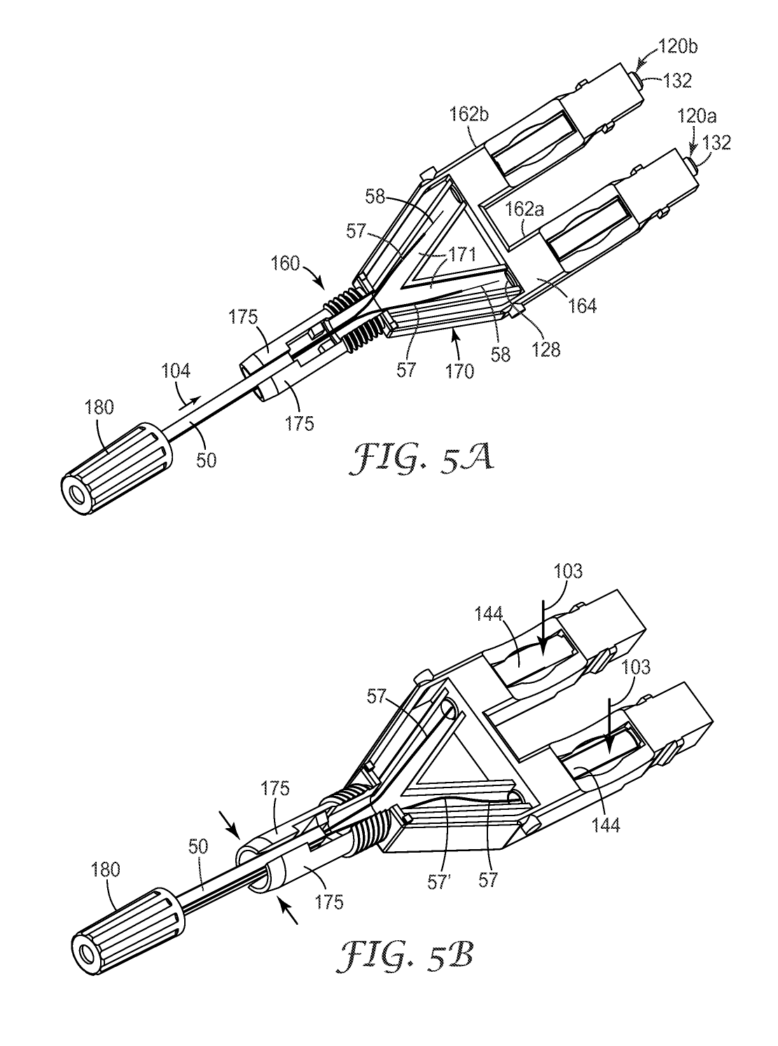

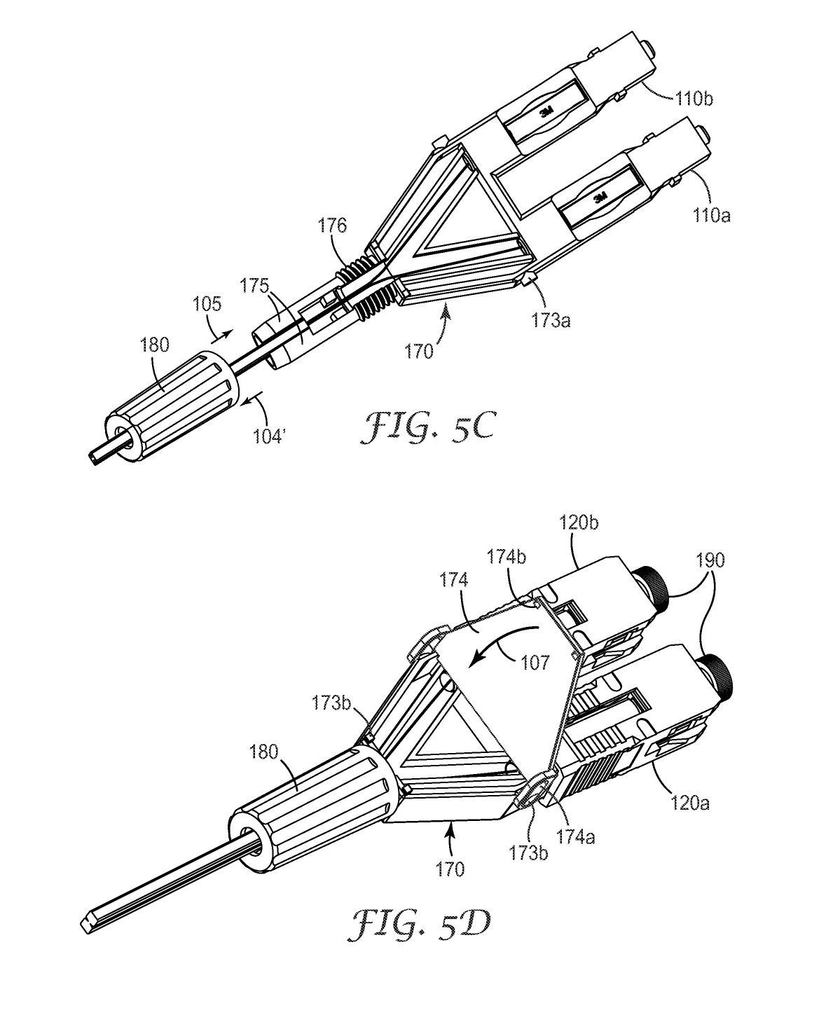

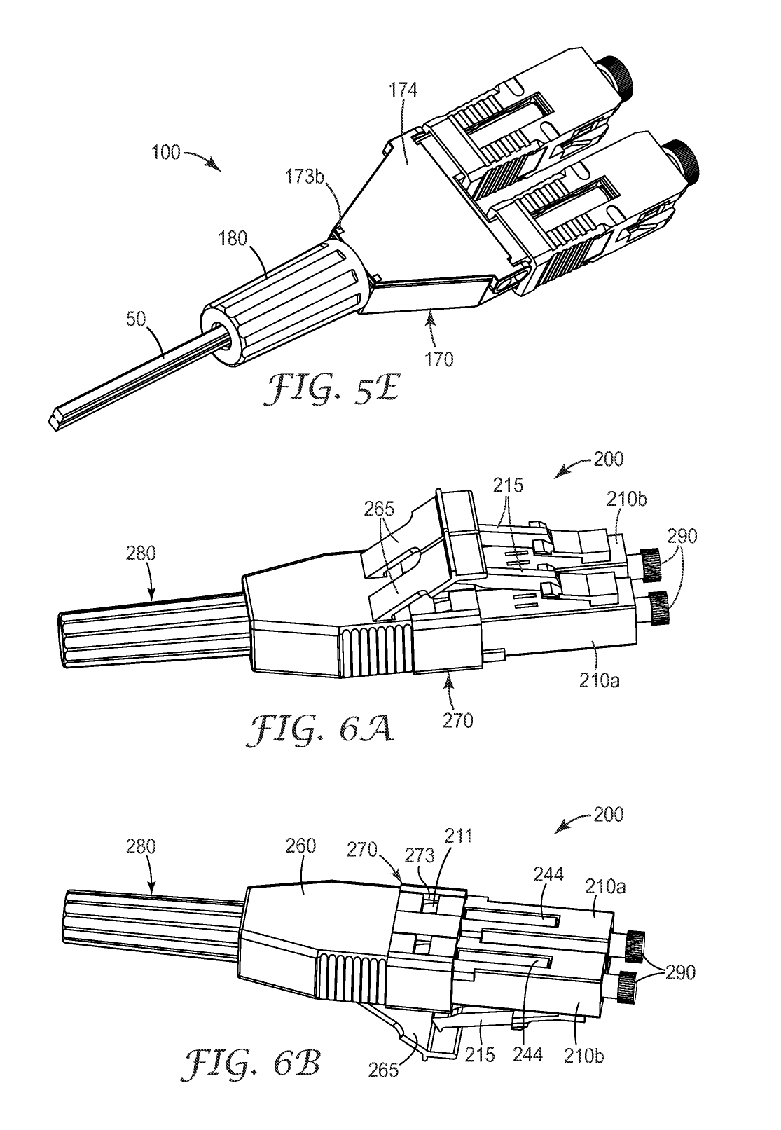

FIGS. 5A-5E show isometric views of the fiber optic connector during different stages of an exemplary field termination process according to another embodiment of the present invention.

FIGS. 6A and 6B are two isometric views of an alternative exemplary fiber optic connector according to an embodiment of the present invention.

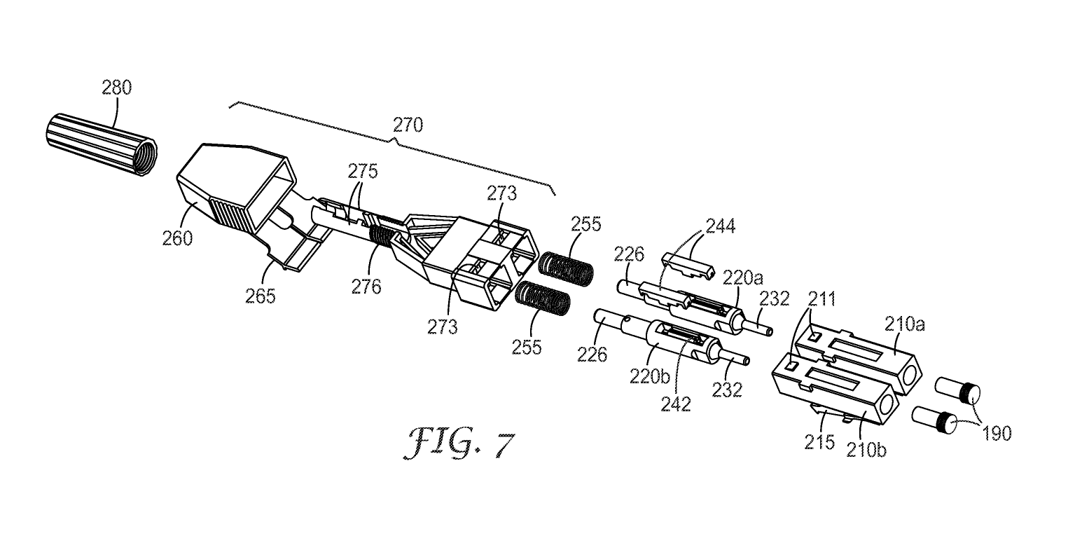

FIG. 7 is an exploded view of an alternative exemplary fiber optic connector according to an embodiment of the present invention.

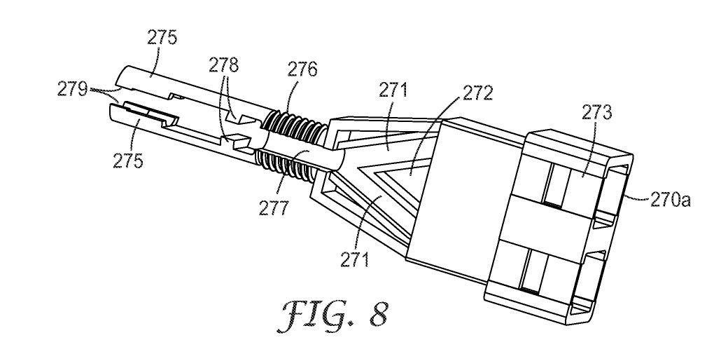

FIG. 8 is an isometric view of an exemplary cable furcation unit of an alternative exemplary fiber optic connector according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to a field mountable fiber optic connector for terminating a dual fiber cable. In particular, the fiber optic connector of the exemplary embodiments is of compact length and is capable of straightforward field termination. Further, the straightforward field termination can be accomplished without the use of a connector termination platform or separate crimping tool. The exemplary connector(s) described herein can be readily installed and utilized for Fiber To The Home (FTTH) and/or Fiber To The X (FTTX) network installations, wireless applications such as providing a fiber optic connection to a wireless radio in the field, and data center applications which can include equipment connections or patching applications. The exemplary connector(s) can be utilized in installation environments that require ease of use when handling multiple connections, especially where labor costs are more expensive.

According to an exemplary embodiment of the present invention, a field mountable fiber optic connector 100 for terminating a dual fiber cable is shown in isometric view in FIG. 1. The components of the fiber optic connector are shown in an exploded view in FIG. 2. FIGS. 3A-3B and 4A-4B show close up views of elements of the fiber optic connector, including the bifurcated housing 160, the collar body 120, and the boot 180.

Fiber optic connector 100 is configured to mate with two adjacent receptacles of a corresponding format. For example, as shown in FIG. 1, exemplary fiber optic connector 100 is configured as having an SC format. However, as would be apparent to one of ordinary skill in the art given the present description, fiber optic connectors having other standard formats, such as ST, FC, and LC connector formats, can also be provided.

As shown in FIGS. 1, 2 and 3A, SC-type field mountable fiber optic connector 100 for terminating a dual fiber cable can include a bifurcated housing 160 having first and second spaced apart, parallel backbone portions 162a, 162b extending from one side of a cable furcation unit 170. First and second outer housing 110a, 110b units are disposed over the first and second backbone portions 162a, 162b, respectively, and a fiber boot 180 can be threadably engaged with threaded receiving portion 176 of the cable furcation unit 170. Dust caps 190 can be placed at the front end of the connector to protect the exposed fiber stub at the end face of the ferrule when not in use.

Outer housings 110a, 110b have an outer geometry configured to be received in an SC receptacle (e.g., an SC coupling, an SC adapter, or an SC socket). As shown in FIG. 2, connector 100 also includes first and second collar bodies 120a, 120b (which can also be referred to as barrels) to house a ferrule 132 with a stub fiber 134 (shown in FIG. 4A) and a splice device. In an exemplary aspect, the slice device can comprise a mechanical splice element 142 and an actuation cap 144. The first and second collar bodies can be disposed within first and second backbone portions 162a, 162b to retain the first and second collar bodies within connector 100.

In one aspect, the first and second backbone portions 162a, 162b provide structural support for the connector 100. In a further aspect, each of the backbone portions has an elongated structure that is attached to one side of the front side of cable furcation unit 170. In an alternative aspect, the first and second backbone portions can be integrally formed with the cable furcation unit of the bifurcated housing by a standard injection molding process.

Each of the backbone portions 162a, 162b includes an opening (not shown) at a front end to allow for insertion of the first and second collar bodies 120a, 120b, respectively. Each backbone portion further includes an access opening 163, which can provide access to actuate a mechanical splice device disposed within the connector collar body housed within each backbone portion. In a preferred aspect, as is shown in FIG. 6C, access openings 163 can have a cut-out or shallow depression formed on the sides to accommodate a user's thumb or finger during actuation of the splice device. Each backbone portion 162a, 162b has an axial bore throughout to permit passage of the optical fiber being terminated.

Each backbone portion 162a, 162b also includes a collar body mount structure 164 configured to receive and secure the collar body 120a, 120b or more generally as collar body 120 (as shown in FIG. 4A) within each backbone portion. In a preferred aspect, collar body mount structure 164 can be a rigid structure formed in an interior region of each backbone portion that has an axial bore 164a extending therethrough. The axial bore can be of appropriate size to receive and engage raised end structures 128 of collar body 120 (see FIG. 4A). In addition, collar body mount structure 164 can also form a shoulder that can be used as a flange to provide resistance against spring 155 that is positioned over the second end portion 126 of the collar body 120. The spring 155 provides and maintains an adequate contact force when two connectors are joined together.

As mentioned previously, bifurcated housing 160 includes a cable furcation unit 170 and first and second spaced apart, parallel backbone portions 162a, 162b extending from one side of the cable furcation unit. The purpose of the cable furcation unit is to separate and guide the optical fibers of a dual fiber optical cable into the first and second collar bodies 120a, 120b disposed within the first and second backbone portions and to assure that the minimum bend radius of the optical fibers is not violated. The cable furcation unit comprises a furcation cavity 172 and a cable gripping portion comprising a pair of cable gripping arms 175 extending from a side (i.e. the rear side) of the cable furcation unit opposite the first and second backbone portions.

The optical fibers can be guided by guide structures within the furcation cavity, such as guide channels 171 or guide walls 171′ shown in the cable furcation units 170, 170′ of FIGS. 3A and 3B, respectively. The guide structures form a bifurcated fork structure designed to guide one optical fiber from fiber guide 177 through the second end portion of the first collar body and guiding the second optical fiber from fiber guide 177 through the second end portion of the second collar body. The guide structures (e.g. guide channels 171) can span the width of cable furcation unit 170 as shown in FIG. 3A or can span only a portion of the width of the cable furcation unit 170′ as shown by the guide walls 171′ in FIG. 3B.

As is also shown in more detail in FIG. 3A, cable furcation unit 170 can further include a pair of cable jacket gripping arms extending from the backside of the cable furcation unit. The cable jacket gripping arms provide clamping of the optical fiber being terminated in the field. A fiber guide 177 can be formed between the cable jacket gripping arms to provide axial alignment support for the optical fiber cable entering the cable furcation unit.

The cable jacket gripping arms 175 can have a threaded receiving portion 176 adjacent to the cable furcation unit that provides for coupling to the fiber boot 180 to the bifurcated housing 160. In an exemplary aspect, the threaded receiving portion comprises a threaded surface formed on an outer portion of the cable jacket gripping arms 175 that are configured to engage a corresponding threaded inner surface 184 of the boot 180 (see FIG. 4B).

Each cable jacket gripping arm 175 can further include one or more stops 178 formed on an interior portion thereof to provide a boundary for the insertion of the jacketed portion 56 of the optical fiber cable 50 being terminated (as explained in more detail below). In addition, each of the cable jacket gripping arms 175 includes a clamping portion 179 formed at the end of each arm. Clamping portions 179 are configured to clamp onto the cable jacket 56 of the optical fiber cable 50 being terminated in connector 100. In an exemplary aspect, cable jacket gripping arms are actuated when the boot 180 is secured to threaded receiving portion 176 enabling gripping portions 179 to grab and hold the cable jacket of the optical fiber cable being terminated. The clamping portions 179 can include raised inner surfaces to permit ready clamping of the cable jacket 56 of optical fiber cable 50. In an alternative aspect, the connector can also include an adapter tube to be placed over the cable jacket of the optical fiber cable, for example, when the optical fiber cable being clamped is of a smaller diameter. In addition, the clamping portion 179 also can serve as a guide structure when inserting fiber cable 50 during the termination process. Thus, boot 180 can be utilized to clamp the fiber jacket 56. The interaction of the boot 180 and the cable jacket gripping arms will be described in greater detail below.

The cable furcation unit can be fitted with a furcation cover 174 to protect the optical fibers disposed within the cavity of the cable furcation unit 170 after actuation of the mechanical splice element. In an exemplary aspect furcation cover can be rotatably attached to the cable furcation unit by hinge receptacles 174a disposed on furcation cover that are configured to mate with hinge pins 173a disposed on the cable furcation unit 170. The furcation cover can be secured in a closed position via an interference fit between locking pins 173b on the cable furcation unit and locking holes 174b disposed in the cover. In the exemplary embodiment shown in FIGS. 2 and 4C, the furcation cover 174 is approximately trapezoidal in shape having either a locking hole or a hinge receptacle located near each corner. In an alternative embodiment, the hinge receptacles can be located on the cable furcation unit and the hinge pins can extend to opposite corners of the furcation cover. In another embodiment, the cove may be attached to the base by a plurality of locking pin/locking hole pairs. For example, four locking pin/locking hole pairs can be disposed near the furcation cover and furcation cavity, respectively, to attach the cover to the bifurcated housing of the connector.

In this exemplary embodiment, connector 100 can be utilized to terminate a dual fiber optical fiber cable 50. Optical fiber cable 50 can be a jacketed cable that includes a cable jacket 56, a coated portion (e.g., with a buffer coating or the like), a fiber portion 58 (e.g., the bare clad/core), and strength members 59. In a preferred aspect, the strength members 59 comprise metallic wires or aramid, Kevlar, or polyester yarn, strands or rods disposed within the fiber jacket 56. In an exemplary aspect, the dual fiber, optical fiber cable 50 can be a fiber reinforced plastic (FRP) optical cable having two optical fibers which is available from Shenzhen SDG Information Company, Ltd. (Shenzhen, China). As would be understood by one of ordinary skill in the art given the present description, the fiber optic connector of the exemplary embodiments can be configured to terminate the fibers of other types of jacketed drop cable, including 3.5 mm drop cable, and others. In an alternative aspect, the dual fiber, optical fiber cable can be a standard cylindrically shaped cable structure having at least two optical fibers, where any of the unterminated optical fibers will be dark fibers used for cable repair in the event that one of the terminated fibers is compromised. In another alternative aspect, the dual fiber, optical fiber cable 50 can be have another external geometry, such as a rectangular-shaped cable, an oval shaped cable or elliptical shaped cable.

According to an exemplary embodiment of the present invention, the first and second outer housings 110a, 110b and bifurcated housing 160 are formed or molded from a polymer material, although metal and other suitably rigid materials can also be utilized. The first and second outer housings 110a, 110b are preferably secured to an outer surface of first and second spaced apart, parallel backbone portions 162a, 162b of the bifurcated housing 160 via snap fit (see e.g., outer engagement surface 165 shown in FIG. 3A).

Referring to FIGS. 2 and 4A, connector 100 further includes a collar body 120. The collar body can be is disposed within the bifurcated housing and retained by one of the first and second backbone portions 162a, 162b. According to exemplary embodiments, the collar body 120 is a multi-purpose element that can house a ferrule 132 and optical stub fiber 134 and a mechanical splice element 142. The collar body is configured to have some limited axial movement within the backbone portion in which it is installed. For example, the collar body 120 can include a collar or shoulder 125 that can be used as a flange to provide resistance against spring 155 (see FIG. 2), interposed between the collar body and the backbone portion. According to an exemplary embodiment of the present invention, collar body 120 can be formed or molded from a polymer material, although metal and other suitable materials can also be utilized. For example, collar body 120 can comprise an injection-molded, integral material.

In particular, collar body 120 includes a first end portion 121 having an opening to receive and house a ferrule 132 having an optical fiber stub or stub fiber 134 secured therein. The collar body also includes a second end portion 126 configured to engage with the collar body mount structure 164 of backbone portion 162a, 162b. In a preferred aspect, second end portion 126 has a raised end structures 128 that has a sloping shape that is insertable through the axial bore 164a of the collar body mount structure 164. Raised end structures 128 of the second end portion can be inserted into the bore and engage against collar body mount structure 164 due to the bias of the spring 155.

The collar body 120 also secures the stub fiber and ferrule in place in the connector 100. Ferrule 132 can be formed from a ceramic, glass, plastic, or metal material to support the stub fiber 134 inserted and secured therein. In a preferred aspect, ferrule 132 is a ceramic ferrule.

A stub fiber 134 is inserted through the ferrule 132, such that a first stub fiber end slightly protrudes from or is coincident or coplanar with the end face of ferrule 132. Preferably, this first stub fiber end is factory polished (e.g., a flat or angle-polish, with or without bevels). A second end of the stub fiber 134 extends part-way into the interior of the connector 100 and is spliced to the optical fiber 58 of an optical fiber cable (such as optical fiber cable 50). Preferably, the second end of stub fiber 134 can be cleaved (flat or angled, with or without bevels).

In one aspect, the second end of stub fiber 134 can be polished in the factory to reduce the sharpness of the edge of the fiber, which can create scrapings (debris) as it is installed in the splice element. For example, an electrical arc, such as one provided by a conventional fusion splicer machine, can be utilized to melt the tip of the fiber and form a rounded end, thereby removing the sharp edges. This electrical arc technique can be used in conjunction with polishing by an abrasive material to better control end face shape while reducing possible distortion of the core. An alternative non-contact method utilizes laser energy to ablate/melt the tip of the fiber.

The stub fiber 134 can comprise standard single mode or multimode optical fiber, such as SMF 28 (available from Corning Inc.). In an alternative embodiment, stub fiber 134 additionally includes a carbon coating disposed on the outer clad of the fiber to further protect the glass-based fiber. In an exemplary aspect, stub fiber 134 is pre-installed and secured (e.g., by epoxy or other adhesive) in ferrule 132, which is disposed in the first end portion 121 of collar body 120. Ferrule 132 is preferably secured within collar body first end portion 121 via an epoxy or other suitable adhesive. Preferably, pre-installation of the stub fiber can be performed in the factory.

Referring back to FIG. 4A, collar body 120 further includes a splice element housing portion 123. In an exemplary aspect, splice element housing portion 123 provides an opening 122 in which a mechanical splice element 142 can be inserted and secured in the central cavity of collar body 120. In an exemplary embodiment, mechanical splice element 142 is part of a mechanical splice device (also referred to herein as a splice device or splice), such as a 3M™ FIBRLOK™ mechanical fiber optic splice device, available from 3M Company, of Saint Paul, Minn.

For example, commonly owned U.S. Pat. No. 5,159,653, incorporated herein by reference in its entirety, describes an optical fiber splice device (similar to a 3M™ FIBRLOK™ II mechanical fiber optic splice device) that includes a splice element that comprises a sheet of ductile material having a focus hinge that couples two legs, where each of the legs includes a fiber gripping channel (e.g., a V-type (or similar) groove) to optimize clamping forces for conventional glass optical fibers received therein. The ductile material, for example, can be aluminum or anodized aluminum. In addition, a conventional index matching fluid can be preloaded into the V-groove region of the splice element for improved optical connectivity within the splice element. In another aspect, no index matching fluid is utilized.

In this exemplary aspect, the mechanical splice element 142 can be configured similar to the splice element from a 3M™ FIBRLOK™ II mechanical fiber optic splice device or a 3M™ FIBRLOK™ 4×4 mechanical fiber optic splice device.

Mechanical splice element 142 allows a field technician to splice the second end of stub fiber 134 to a stripped fiber portion 58 of an optical fiber cable 50 at a field installation location. In an exemplary embodiment, utilizing a 3M™ FIBRLOK™ II mechanical fiber optic splice device, splice device can include mechanical splice element 142 and an actuation cap 144 (FIG. 2). In operation, as the actuation cap 144 is moved from an open position to a closed position (e.g. downward in the embodiment depicted in FIG. 2 or in the direction of arrow 103 in FIG. 5B), one or more cam bars located on an interior portion of the actuation cap 144 can slide over the splice element legs, urging them toward one another. Two fiber ends, (e.g., one end of stub fiber 134 and one end of optical fiber 58 from optical fiber cable 50) are held in place in grooves formed in the splice element and butted against each other and are spliced together in a channel, such as a V-groove channel to provide sufficient optical connection, as the element legs are moved toward one another.

Mechanical splice element 142 is mountable in a mounting device or cradle 124 (partially shown in FIG. 4) located in splice element housing portion 123 of collar body 120. In an exemplary embodiment, cradle 124 is integrally formed in collar body 120, e.g., by molding. Cradle 124 can secure (through e.g., snug or snap-fit) the axial and lateral position of the mechanical splice element 142. The cradle 124 can be configured to hold the mechanical splice element such that the splice device cannot be rotated or easily moved forward or backward once installed.

The mechanical splice device allows a field technician to splice the second end of stub fiber 134 to the fiber of an optical fiber cable 50 at a field installation location. The term “splice,” as utilized herein, should not be construed in a limiting sense since splice device can allow removal of a fiber. For example, the element can be “re-opened” after initial actuation, where the splice element housing portion can be configured to allow for the removal of the actuation cap if so desired by a screw driver or similar device. This configuration permits repositioning of the spliced fibers, followed by replacement of the actuation cap to the actuating position.

As mentioned above, fiber boot 180 can be utilized for several purposes with fiber optic connector 100. As shown in FIG. 4B, boot 180 includes a tapered body 182 having an axial bore throughout. The boot 180 includes threaded grooves 184 formed on an inner surface of the body 182 at the opening 185, where the grooves are configured to engage with the correspondingly threaded mounting structure of the threaded receiving portion 176 of the bifurcated housing 160. In addition, the axial length of boot 180 is configured such that a rear section 183 of the boot, which has a smaller opening than at front opening 185, engages the clamp portions 179 of the cable jacket gripping arms 175. For example, as is explained in more detail below, as the boot 180 is secured onto the threaded receiving portion 176 of the bifurcated housing, the axial movement of the boot relative to the cable jacket gripping arms (see arrow 105 in FIG. 5C) forces the cable jacket gripping arms to move radially inwards so that the fiber jacket 56 is tightly gripped by clamp portions 179.

In an exemplary aspect, boot 180 is formed from a rigid material. For example, one exemplary material can comprise a fiberglass reinforced polyphenylene sulfide compound material. In another aspect, the materials used to form the boot 180 and the bifurcated housing 160 are the same.

As mentioned above, the fiber optic connector of the exemplary embodiments is of compact length and is capable of straightforward field termination without the use of a connector termination platform or separate crimping tool. An exemplary termination process is now described with reference to FIGS. 5A-5E. Please note that reference numbers used in these figures correspond with like features from FIGS. 1-4B.

As shown in FIG. 5A, the fiber optic connector is partly assembled by inserting the first and second collar bodies 120a, 120b with ferrules 132 and stub fibers (not shown) secured therein into open ends of first and second backbone portions 162a, 162b of the bifurcated housing 169. This step may be performed prior to the field termination process or during the field termination process. As mentioned above, the raised end structures 128 at the second end of each collar body is inserted into the bore of collar body mount structure 164. The spring 155 will provide some bias against axial movement after insertion.

For field termination, optical fiber cable 50 is prepared by removing a portion of the fiber cable jacket 56, cutting the strength members approximately flush with the end face of the cable jacket, and stripping off a coated portion off of each fiber near the terminating fiber end to leave a bare portion of optical fiber 58 and cleaving (flat or angled) the fiber end to match the orientation of the pre-installed stub fiber. In an exemplary aspect, about 50 mm of the cable jacket 56 can be removed and about 20 mm of the coated portion at the terminal ends of the fiber are removed. The twin optical fibers 58 are cleaved simultaneously, leaving about 10 mm of stripped bare fiber. For example, a commercial fiber cleaver such as an Ilsintech MAX CI-01 or the Ilsintech MAX CI-08, available from Ilsintech, Korea (not shown) can be utilized to provide a flat or an angled cleave. No polishing of the fiber end is required, as a cleaved fiber can be optically coupled to the stub fiber 134 in the splice device. The boot 180 can be slid over the optical fiber cable 50 for later use.

As shown in FIG. 5A, optical fiber cable 50 can be inserted in the direction of arrow 104 through the rear end of the connector (i.e., between cable gripping arms 175). Each of the optical fibers is guided through the cable furcation unit 170 by guiding channels 171 and into the rear end of the first and second collar bodies 120a, 120b. In this manner, the prepared fiber end can be spliced to the fiber stub with the mechanical splice device. The optical fiber cable 50 is continually inserted until the coated portion of the fiber begins bowing at 137′ (which occurs as the end of optical fiber 58 meets stub fiber 134 with sufficient end loading force within the splice element held within the collar body) as shown in FIG. 5B.

The splice device can then be actuated while the fibers are subject to an appropriate end loading force. To actuate the splice device, FIG. 5B shows that a user can simultaneously squeezing together cable gripping arms 175 to hold the cable securely while pressing downward (with a modest thumb or finger force) in the direction of arrow 103 onto the cap 144 of the splicing device to actuate the splice element within each collar body. The fiber jacket can then be released at cable gripping arms 175 and moved back as in a direction indicated by arrow 104′, thereby removing the fiber bow as shown in FIG. 5C.

The boot 180 (which is previously placed over optical fiber cable 50) is then pushed over cable gripping arms 175 in a direction indicated by arrow 105. As is shown in FIG. 5C, the boot 180 can be pushed axially toward threaded receiving portion 176 of the cable furcation unit 170 and screwed onto the threaded receiving portion to secure the boot in place. As mentioned above, the installation of the boot 180 onto the threaded receiving portion of the bifurcated housing tightens the collet-style cable portion (e.g. cable gripping arms 175) onto the fiber jacket.

As shown in FIG. 5D, the first and second outer housings 110a, 110b are slid over first and second backbone portions, respectively. In addition, furcation cover 174 is snapped on to the cable furcation unit by engaging the hinge receptacles 174a disposed on furcation cover with hinge pins 173a disposed on the cable furcation unit 170. The cover can be secured in a closed position by rotating the furcation cover around the pivot axis defined by the hinge pins on the cable furcation unit as shown by arrow 107. The cover is secured in a closed position via an interference fit between locking pins 173b on the cable furcation unit and locking holes 174b disposed in the furcation cover as shown in FIGS. 5D and 5E yielding a fully assembled field mountable dual fiber optical connector 100. In an alternative aspect the furcation cover can be attached to the cable furcation unit prior the insertion of the cable into the bifurcated housing.

Thus, the above termination procedure can be accomplished without the use of any additional fiber termination platform or specialized tool. The fiber optic connector is re-usable in that the actuation cap can be removed and the above steps can be repeated.

An alternative embodiment of a field mountable fiber optic connector of the current invention is shown in FIGS. 6A-6B, 7, and 8. The figures show an LC-type field mountable fiber optic connector 200 for terminating a dual fiber cable. FIG. 6A shows a top view of the exemplary assembled connector. FIG. 6B shows a bottom view of the exemplary assembled connector. FIG. 7 shows an exploded view of the exemplary connector of FIGS. 6A and 6B. FIG. 8 is a detail view of the cable furcation unit of FIGS. 6A and 6B.

According to an exemplary embodiment of the present invention, optical fiber connector 200 can include a connector body having a housing and a fiber boot 180. In this exemplary embodiment, the housing includes a cable furcation unit 270 having a first end and a second end, and first and second outer housings 210a, 210b attached to the first end of the a cable furcation unit, such that the first and second outer housings are configured to be mateable with two adjacent receptacles.

Outer housings 210a, 210b have an outer LC-shaped body format. In addition, the housing includes a housing latch 215 disposed on the outer surface of each of the outer housing units. The housing latch is configured to engage an LC receptacle and secure the connector 200 in place. The housing latches 215 are depressible and have sufficient flexibility so that the connector can be disengaged/released from adjacent LC receptacles when the housing latches are activated with a modest pressing force. In addition, as shown in FIG. 6A, the housing latches 215 extend rearward away from the front face of connector 200.

Optical connector 200 further includes first and second collar bodies 220a, 220b respectively disposed in the first and second outer housings 210a, 210b. The outer housings units can be secured to the cable furcation unit via a mechanical connection such as latch tabs 211 formed on the outer surface of each outer housing unit which mate with opening 273 formed near the front end of the cable furcation unit. In an exemplary aspect, the first and second outer housings units can be slid into the front end of the cable furcation unit until the latch tabs engage with the openings in the cable furcation device.

In an exemplary aspect, each collar body 220a, 220b includes a stub fiber mounted in a ferrule 232 disposed in a first end of the collar body and a mechanical splice device disposed within the collar body. The stub fiber has a first end proximate to an end face of the ferrule and a second end configured to splice to one of the optical fiber from the dual optical fiber cable within the splice device. In an exemplary aspect, the splice device comprises a splice element 242 and an actuation cap 244, similar to that previously described.

As mentioned previously, connector housing includes a cable furcation unit 170 to separate and guide the optical fibers of a dual fiber optical cable into the first and second collar bodies 220a, 220b disposed within the connector to ensure that the minimum bend radius of the optical fibers is not violated. The cable furcation unit comprises a furcation cavity 272 and a cable gripping portion comprising a pair of cable gripping arms 275.

The optical fibers from a dual fiber cable can be guided by guide structures within the furcation cavity, such as guide channels 271 shown in FIG. 8. The guide structures form a bifurcated fork structure designed to guide one optical fiber from fiber guide 277 through the second end portion of the first collar body 220a and guiding the second optical fiber from fiber guide 277 through the second end portion of the second collar body 220b. The guide structures (e.g. guide channels 271) can span the width of cable furcation unit 270 or can span only a portion of the width of the cable furcation unit if desired.

The cable jacket gripping arms 275 extend from the backside of the cable furcation device. The cable jacket gripping arms provide clamping of the optical fiber being terminated in the field. A fiber guide 277 can be formed between the cable jacket gripping arms to provide axial alignment support for the optical fiber cable entering the cable furcation unit.

The cable jacket gripping arms 275 can have a threaded receiving portion 276 adjacent to the cable furcation unit that provides for coupling to the fiber boot 280, which is analogous to boot 180 described previously with respect to FIG. 4B. In an exemplary aspect, the threaded receiving portion comprises a threaded surface formed on an outer portion of the cable jacket gripping arms 275 that are configured to engage a corresponding threaded inner surface 184 (see FIG. 4B) of the boot 280. Boot 280 actuates the fiber jacket clamping portion (i.e. the cable jacket gripping arms 275) of the cable furcation unit upon attachment to the threaded receiving portion.

Each cable jacket gripping arm 275 can further include one or more stops 278 formed on an interior portion thereof to provide a boundary for the insertion of the cable jacket 56 of the optical fiber cable 50 being terminated (as explained in more detail below). In addition, each of the cable jacket gripping arms 275 includes a clamping portion 279 formed at the end of each gripping arm. Clamping portions 279 are configured to clamp onto the cable jacket of the optical fiber cable being terminated in connector 200. In an exemplary aspect, cable jacket gripping arms have a collet-type, split body shape that is actuated when the boot is secured to threaded receiving portion 276 enabling clamping portions 279 to grab and hold the cable jacket of the optical fiber cable being terminated. The clamping portions 279 can include raised inner surfaces to permit ready clamping of the cable jacket of optical cable. In an alternative aspect, the connector can also include an adapter tube to be placed over the cable jacket of the optical fiber cable, for example, when the optical fiber cable being clamped is of a smaller diameter. In addition, the clamping portions 279 can also serve as a guide structure when inserting fiber cable into the cable furcation unit during the termination process.

The cable furcation unit can be fitted with a furcation cover 260 to protect the optical fibers disposed within the cavity of the cable furcation unit 270 after actuation of the mechanical splice element. In an exemplary aspect, furcation cover can be a clip that closely conforms to the outer dimensions of the cable furcation unit such that it can be slid into position over the cable furcation unit after termination of the optical fibers in the splice element. The furcation cover can be secured in a closed position via an interference fit.

In addition, furcation cover 260 can further include a trigger 265 or forward extending latch that is configured to engage housing latch 215 when the trigger 165 is activated by a modest pressing force. Due to the small format size of the dual fiber LC connector 200 and its corresponding receptacles, and also the tight space requirements of devices having LC receptacles, it can be difficult to directly access housing latch 215 to releases the LC connector. Accordingly, the trigger 235 provides a straightforward access point for a user to release the dual fiber LC connector.

To mount the exemplary dual fiber LC connector on to the terminal end of a dual fiber optical cable, the cable can be prepared as outlined previously. The boot and then the furcation cover are threaded onto the cable. The cable is fed into connector 200 as described previously until a bow is formed the optical fiber residing in the cable furcation unit. The splice device can then be actuated while the fibers are subject to an appropriate end loading force. To actuate the splice device, a user can simultaneously squeeze together cable gripping arms to hold the cable securely while pressing downward (with a modest thumb or finger force) onto the actuation cap 244 of the splicing device to actuate the splice element within each collar body of connector 200. The fiber cable can then be released at cable gripping arms 275 and moved back to remove the fiber bow. The furcation cover is then slid over the cable furcation unit and is attached to the connector body by screwing onto the threaded receiving portion.

The fiber optic connectors described above can be used in many conventional fiber optic connector applications where dual fiber drop cables and/or jumpers are used. The fiber optic connectors described above can also be utilized for termination (connectorization) of optical fibers for interconnection and cross connection in optical fiber networks inside a fiber distribution unit at an equipment room or a wall mount patch panel, inside pedestals, cross connect cabinets or closures or inside outlets in premises for optical fiber structured cabling applications. The fiber optic connectors described above can also be used in termination of optical fiber in optical equipment. In addition, one or more of the fiber optic connectors described above can be utilized in alternative applications.

As mentioned above, the fiber optic connector of the exemplary embodiments is of compact length and is capable of straightforward field termination with reduced assembly times. Such exemplary connectors can be readily installed and utilized for FTTP and/or FTTX network installations.

Various modifications, equivalent processes, as well as numerous structures to which the present invention may be applicable will be readily apparent to those of skill in the art to which the present invention is directed upon review of the present specification.

We claim:

1. A field mountable fiber optic connector for terminating a dual optical fiber cable, comprising:
a bifurcated housing having first and second spaced apart, parallel backbone portions extending from a cable furcation unit; wherein the cable furcation unit comprises a threaded receiving portion and a fiber jacket clamping portion to clamp a cable jacket of the dual optical fiber cable;
first and second collar bodies respectively disposed in the first and second backbone portions, wherein each collar body includes a fiber stub disposed in a first end of the collar body, the fiber stub including a stub fiber mounted in a ferrule and having a first end proximate to an end face of the ferrule and a second end, wherein each collar body further includes a mechanical splice device disposed within the collar body, the mechanical splice device configured to splice the second end of the stub fiber to an optical fiber from the dual optical fiber cable;
first and second outer housings respectively disposed over the first and second backbone portions and wherein the first and second outer housings are configured to be mateable with two adjacent receptacles; and
a boot attachable to the threaded receiving portion of the cable furcation unit, wherein the boot actuates the fiber jacket clamping portion of the cable furcation unit upon attachment to the threaded receiving portion.

2. The fiber optic connector of claim 1, wherein the fiber optic connector is configured to mate with a pair of adjacent SC receptacles.

3. The fiber optic connector of claim 1, wherein the mechanical splice device comprises a mechanical splice element and an actuation cap.

4. The fiber optic connector of claim 1, wherein the fiber jacket clamping portion comprises a collet-type, split body shape.

5. The fiber optic connector of claim 4, wherein the fiber jacket clamping portion comprises a pair of cable gripping arms.

6. The fiber optic connector of claim 1, wherein the boot attaches to the bifurcated housing via a screw-type mechanism.

7. The fiber optic connector of claim 1, wherein the dual optical fiber cable is an FRP-style cable.

8. A field mountable fiber optic connector for terminating a dual optical fiber cable, comprising:
a cable furcation unit having a first end and a second end; wherein the cable furcation unit comprises a threaded receiving portion and a fiber jacket clamping portion to clamp a cable jacket of the dual optical fiber cable;
first and second outer housings attached to the first end of the a cable furcation unit, wherein the first and second outer housings are configured to be mateable with two adjacent receptacles;
first and second collar bodies respectively disposed in the first and second outer housing units, wherein each collar body includes a fiber stub disposed in a first end of the collar body, the fiber stub including a stub fiber mounted in a ferrule and having a first end proximate to an end face of the ferrule and a second end, wherein each collar body further includes a mechanical splice device disposed within the collar body, the mechanical splice device configured to splice the second end of the stub fiber to an optical fiber from the dual optical fiber cable; and
a boot attachable to the threaded receiving portion of the cable furcation unit, wherein the boot actuates the fiber jacket clamping portion of the cable furcation unit upon attachment to the threaded receiving portion.

9. The fiber optic connector of claim 8, wherein the fiber optic connector is configured to mate with a pair of adjacent LC receptacles.

10. The fiber optic connector of claim 8, wherein the fiber jacket clamping portion comprises a collet-type, split body shape.

11. The fiber optic connector of claim 10, wherein the fiber jacket clamping portion comprises a pair of cable gripping arms.

12. The fiber optic connector of claim 8, wherein the boot attaches to connector via a screw-type mechanism.

13. The fiber optic connector of claim 8, wherein the dual optical fiber cable is an FRP-style cable.

14. The fiber optic connector of claim 8, further comprising a latch disposed on each of the first and second outer housing units.
